(19) United States
(12) Patent Application Publication
(10) Pub. No.: US 2026/0162840 A1
(43) Pub. Date: Jun. 11, 2026

(54) Dual use of installed nuclear power module sensors for international safeguards

(71) Applicant: NuScale Power, LLC, Corvallis, OR (US)

(72) Inventors: José N. Reyes, JR., Corvallis, OR (US); Kevin J. Deyette, Albany, OR (US); Paul J. Evans, JR., Neotsu, OR (US); Levi Schimelfining, Lebanon, OR (US); Rob Meyer, Corvallis, OR (US); Christopher M. Noack, Shelbyville, KY (US)

(21) Appl. No.: 19/409,473

(22) Filed: Dec. 4, 2025

Related U.S. Application Data
(60) Provisional application No. 63/728,205, filed on Dec. 5, 2024.

(51) Int. Cl. G21C 17/003; G21D 3/04

(52) U.S. Cl. CPC G21C 17/003; G21D 3/04

(57) ABSTRACT

A nuclear power plant system, comprising a crane, a nuclear reactor, and a plurality of instruments, wherein an instrument of the plurality is configured to monitor a parameter of the nuclear power plant system, each instrument of the plurality is configured to transmit data to a local data collection system, and each instrument of the plurality is configured to transmit the data to an external data collection system.

### CROSS-REFERENCED TO RELATED APPLICATIONS

This application claims priority to U.S. Provisional Patent Application No. 63/728,205, filed Dec. 5, 2024, and titled “Dual Use of Installed Nuclear Power Module Sensors for International Safeguards,” which is incorporated herein by reference in its entirety.

### BACKGROUND

Operation of a Nuclear Reactor Plant is closely regulated and requires multiple inspections from multiple entities. In addition to routine inspections conducted by plant operators to ensure proper operation, various agencies (e.g., U.S. Nuclear Regulatory Commission (NRC), International Atomic Energy Agency (IAEA), U.S. Department of Energy (DOE), etc.) require inspections of the Nuclear Reactor Plant for a variety of reasons. In some instances, it may be impracticable and/or inefficient to be present for multiple in-person and on-site inspections in a year. Accordingly, a means of establishing and maintaining verifying proper operation without having to be on-site is necessary.

### BRIEF DESCRIPTION OF THE DRAWINGS

FIG. 1 schematically illustrates a representation of a Nuclear Power Plant that includes a Nuclear Power Module (NPM) implementing a dual use for NPM parameter, according to an embodiment of this disclosure.

FIG. 2 schematically illustrates an NPM implementing dual use for a Containment Vessel (CNV) Pressure instrument, according to an embodiment of this disclosure.

FIG. 3 schematically illustrates a Nuclear Power Plant system implementing dual use for a main hoist load cell, according to an embodiment of this disclosure.

FIG. 4 schematically illustrates an NPM implementing dual use for a Module Protection System (MPS), according to an embodiment of this disclosure.

FIG. 5 schematically illustrates a Nuclear Power Plant system implementing dual use for the NMS-Flood subsystem, according to an embodiment of this disclosure.

FIG. 6 is a partial schematic, partial cross-sectional view of a nuclear reactor system configured in accordance with embodiments of the present technology.

FIG. 7 is a partial schematic, partial cross-sectional view of a nuclear reactor system configured in accordance with additional embodiments of the present technology.

FIG. 8 is a schematic view of a nuclear power plant system including multiple nuclear reactors in accordance with embodiments of the present technology.

### DETAILED DESCRIPTION

### Overview

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity. This disclosure is directed to system and methods for utilizing pre-existing instrumentation within a Nuclear Reactor (e.g., Nuclear Power Module (NPM) or other advanced reactor) to provide not only operational parameters for use by power plant operators, but to also provide data relevant for an outside agency (e.g., U.S. Nuclear Regulatory Commission (NRC), International Atomic Energy Agency (IAEA), U.S. Department of Energy (DOE), etc.), as required.

For example, the International Atomic Energy Agency (IAEA) works with multiple countries to promote the safe, secure, and peaceful use of nuclear technology for non-weapon use (e.g., medical isotope production, electricity production, etc.) by ensuring that nuclear facilities adhere to a number of technical measures. The IAEA refers to these technical measures as Safeguards. To ensure nuclear facilities comply with the Safeguards, the IAEA requires a Continuity of Knowledge (CoK) for all nuclear reactors deployed in a non-nuclear weapon state, in accordance with the Safeguards Agreement for the design.

Typically, the IAEA maintains a CoK through multiple methods, including installation of sensors, cameras, control tags, and via site inspections. Because of the integral pressurized water design of a nuclear power module (NPM), there is insufficient space and access to install typical IAEA monitoring equipment in an NPM. Additionally, a nuclear facility that contains multiple NPMs may need to consider a staggered refueling schedule for each NPM, which may result in several refueling periods within a calendar year.

Typically, the IAEA has inspectors on-site during reactor refueling. But for nuclear facilities conducting multiple refueling periods in the same calendar year (e.g., power plants utilizing multiple NPMs), it may not be cost-effective for IAEA inspectors to be on site and may contribute to increased radioactive exposure for inspectors. Although inspection constraints were only discussed as they apply to the IAEA, the same constraints may frustrate the purpose of other agencies (e.g., NRC, DOE, U.S. Environmental Protection Agency (EPA), etc.).

### Illustrative Embodiments

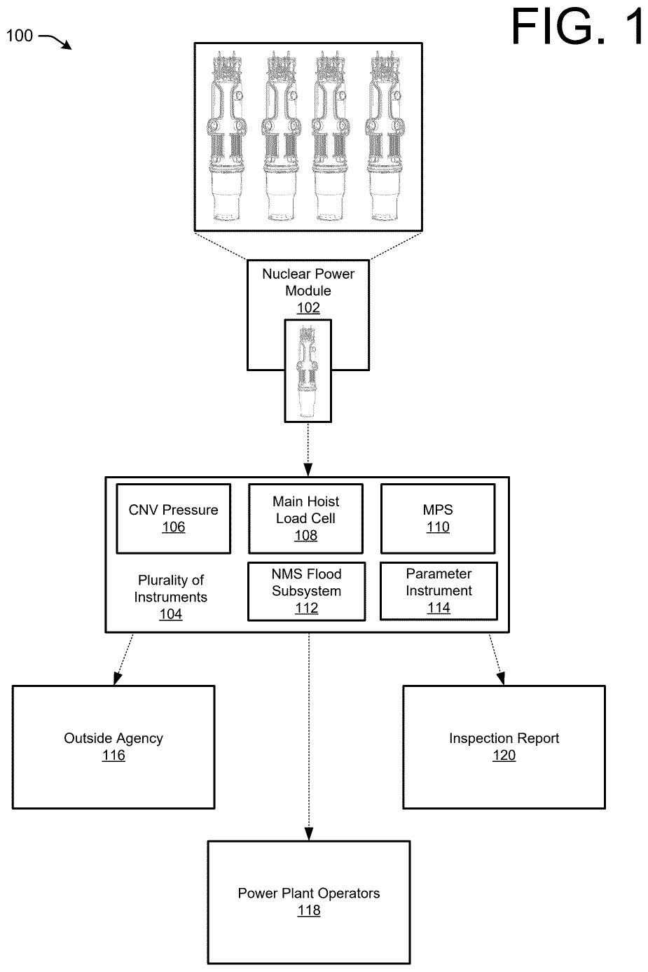

FIG. 1 schematically illustrates a representation of a Nuclear Power Plant 100 (“Plant 100”) that includes a Nuclear Power Module (NPM) 102 implementing a dual use for a plurality of instruments 104. In an embodiment, the plurality of instruments 104 may include a Containment Vessel (CNV) pressure instrument 106, a main hoist load cell 108, a Module Protection System (MPS) 110, a Neutron Monitoring System (NMS) Flood Subsystem 112, and one or more additional parameter instrument(s) 114.

In an embodiment, the Plant 100 may collect data (e.g., first data, second data, third data, etc.) from the plurality of instruments 104 and distribute the data to an external data collection system (i.e., to an Outside Agency 116 (e.g., International Atomic Energy Agency (IAEA), U.S. Department of Energy (DOE), U.S. Nuclear Regulatory Commission (NRC), etc.)), a local data collection system (i.e., a system to collect operation data for use by the Power Plant Operators 118), and/or to generate an inspection report 120 that may be used for analysis, historical data, etc. In an embodiment, the data distributed to the Power Plant Operators 118 may be used to operate and maintain the Plant 100, trend analysis, maintenance analysis, performance analysis, etc.

In an embodiment, the data may be unalterable. For example, the plurality of instruments 104 may be configured to only collect and distribute (e.g., transmit, relay, send, etc.) the data that is collected. In an embodiment, the data may be encrypted, formatted, and/or converted, as necessary, before being distributed to the Outside Agency 116. For example, in order to prevent the accidental disclosure of restricted data, the data may be encrypted. Additionally, or alternatively, the data may be formatted, as required, in order to be compatible with the system(s) used by the Outside Agency 116.

In an embodiment, the plurality of instruments 104 may be used intermittently, as required, to collect and distribute data. For example, the Plant 100 may utilize the CNV pressure instrument 106 to collect data related to the pressure within the CNV during a particular plant operation (e.g., power production, steam production, etc.) and not during another plant operation. In an embodiment, the Outside Agency 116 and the Power Plant Operators 118 may receive raw data in real time as the data is produced (i.e., without interference, amendment, or alteration). For example, the Plant 100 may collect raw data from the plurality of instruments 104 and simultaneously distribute the raw data to the Outside Agency 116 and to the Power Plant Operators 118.

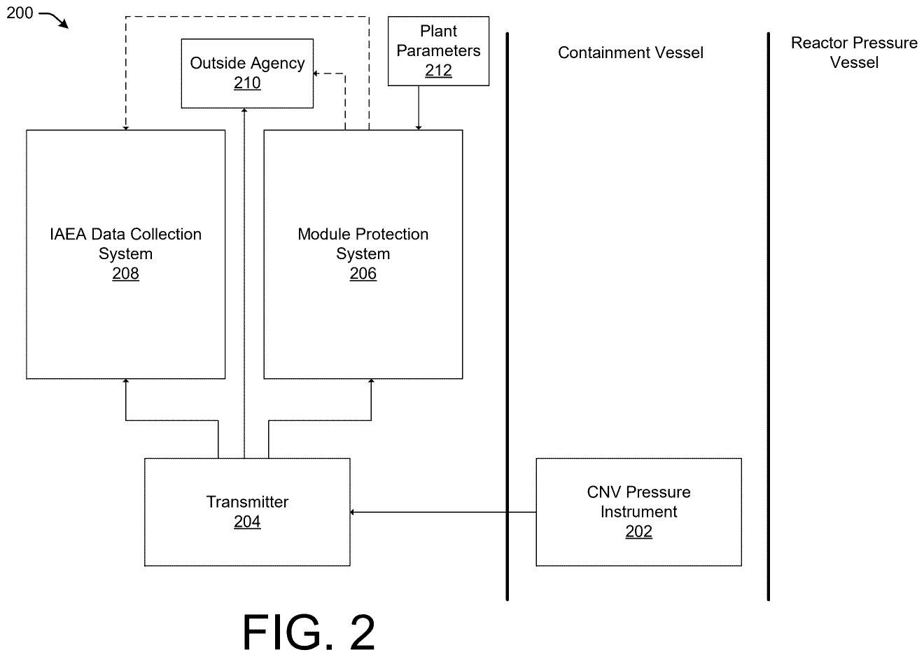

FIG. 2 schematically illustrates an NPM 200 implementing a dual use for a Containment Vessel (CNV) pressure instrument 202. In an embodiment, the CNV pressure instrument 202 may collect raw data related to the pressure within the CNV (e.g., positive pressure and negative pressure) and transmit the raw data to a transmitter 204. In an embodiment, the CNV pressure instrument 202 may transmit the raw data to the transmitter 204 in real time (i.e., immediately after being collected and without amendment and/or alteration). In an embodiment, the transmitter 204 may transmit the raw data to a Module Protection System 206 (MPS), an IAEA Data Collection System 208, and/or any other Outside Agency 210 (e.g., U.S. Department of Energy (DOE), U.S. Nuclear Regulatory Commission (NRC), etc.), as required.

In an embodiment, a portion of the raw data may be partitioned (e.g., separated, segregated, filtered, etc.) based on one or more criteria, as determined to be relevant to the Module Protection System 206 (MPS), an IAEA Data Collection System 208, and/or any other Outside Agency 210 (e.g., U.S. Department of Energy (DOE), U.S. Nuclear Regulatory Commission (NRC), etc.) receiving the raw data. For example, only information relevant to reactor fuel may be desired, thus a portion of the raw data related to the reactor fuel may be separated from the raw data collected and transmitted to the desired location.

In an embodiment, the MPS 206 may receive data (e.g., second data, etc.) from one or more plant parameters 212. In an embodiment, the MPS 206 may provide data to the Outside Agency 210. In an embodiment, the MPS 206 may provide data to the IAEA Data Collection System 208. In an embodiment, the IAEA Data Collection System 208 may receive data related to the pressure within the CNV from the CNV Pressure Instrument 202 via the transmitter 204 and receive data related to the pressure within the CNV from the CNV Pressure Instrument 202 via the MPS 206. By receiving the data related to pressure within the CNV from two different sources (the transmitter 204 and the MPS 206), the IAEA Data Collection System 208 may ensure redundant sources of data related to pressure within the CNV. Additionally, and/or alternatively, the IAEA Data Collection System 208 may compare the data to ensure accuracy.

In an embodiment, the Outside Agency 210 may receive data related to the pressure within the CNV from the CNV Pressure Instrument 202 via the transmitter 204 and receive data related to the pressure within the CNV from the CNV Pressure Instrument 202 via the MPS 206. By receiving the data related to pressure within the CNV from two different sources (the transmitter 204 and the MPS 206), the Outside Agency 210 may ensure redundant sources of data related to pressure within the CNV. Additionally, and/or alternatively, the Outside Agency 210 may compare the data to ensure accuracy.

In an embodiment, the CNV Pressure Instrument 202 may include a Narrow Range Containment Vessel (CNV) Pressure instrument. The Narrow Range CNV Pressure Instrument is one of four identical instruments that provide inputs to the MPS related to pressure within the CNV. In an embodiment, a second output from one of the four instruments may provide an input to the MPS that is related to pressure within the CNV. In an embodiment, the MPS may convert input(s) from one of the four instruments to a signal that is usable by the IAEA data collection system, and send the converted signal directly to the IAEA data collection system 208. The dual use of one pressure instrument alleviates the problem of placing an instrument unique to the IAEA within the CNV, and also removes the authentication concern, by receiving data directly from the instrument.

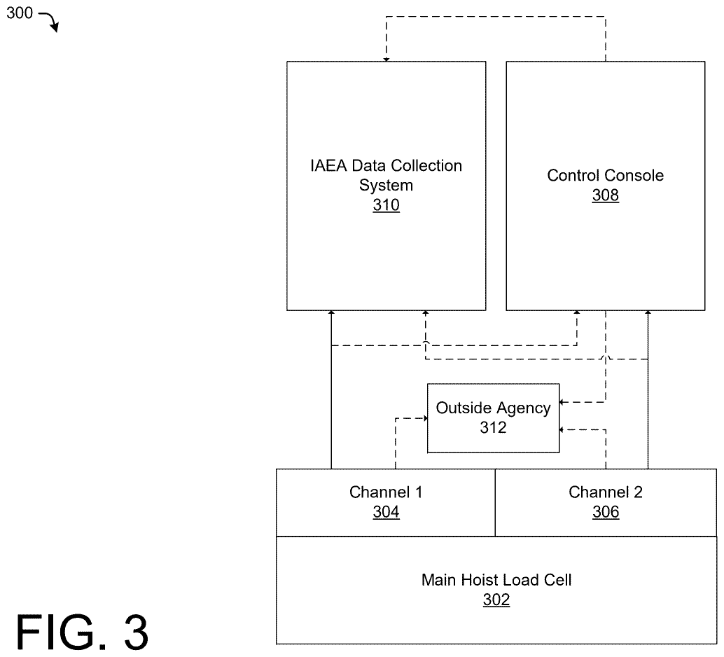

FIG. 3 schematically illustrates a Nuclear Power Plant system 300 implementing dual use for a main hoist load cell 302. In an embodiment, the main hoist load cell 302 may include a channel 304 (e.g., first channel, channel 1, primary channel, etc.) and a channel 306 (e.g., second channel, channel 2, secondary channel, etc.) to provide data related to the load on the fuel handling crane to a Control Console 308 and an IAEA Data Collection System 310. In an embodiment, the first channel 304 may be configured to transmit data related to the load on the fuel handling crane to the IAEA Data Collection System 310. In an embodiment, the second channel 306 may be configured to transmit data related to the load on the fuel handling crane to the Control Console 308.

In an embodiment, the main hoist load cell 302 is the instrument that measures the load on the fuel handing crane. In an embodiment, the main hoist load cell 302 may include a multi-channel (e.g., dual channel, etc.) load cell. In addition to providing data to the Control Console 308 for observation and trend analysis of the power plant operators, the main hoist load cell 302 may also provide data related to the load on the fuel handling crane to the IAEA Data Collection System 310. The dual use of the main hoist load cell negates the need for a separate instrument unique to the IAEA on the fuel handing equipment, which may reduce the production of radioactive material.

In an embodiment, an Outside Agency 312 and/or the IAEA Data Collection System 310, may receive first data related to the load on the fuel handling crane from the main hoist load cell 302 via the first channel 304 and/or receive second data related to the load on the fuel handling crane from the main hoist load cell 302 via the second channel 306. Additionally, and/or alternatively, the Outside Agency 312 and/or the IAEA Data Collection System 310, may receive first data related to the load on the fuel handling crane from the main hoist load cell 302 via the Control Console 308.

By receiving the data related to the load on the fuel handling crane from at least two different sources (the main hoist load cell 302 and the Control Console 308), the Outside Agency 312 and/or the IAEA Data Collection System 310, may ensure redundant sources of data related to the load on the fuel handling crane. Additionally, and/or alternatively, the Outside Agency 312 and/or the IAEA Data Collection System 310 may compare the data to ensure accuracy.

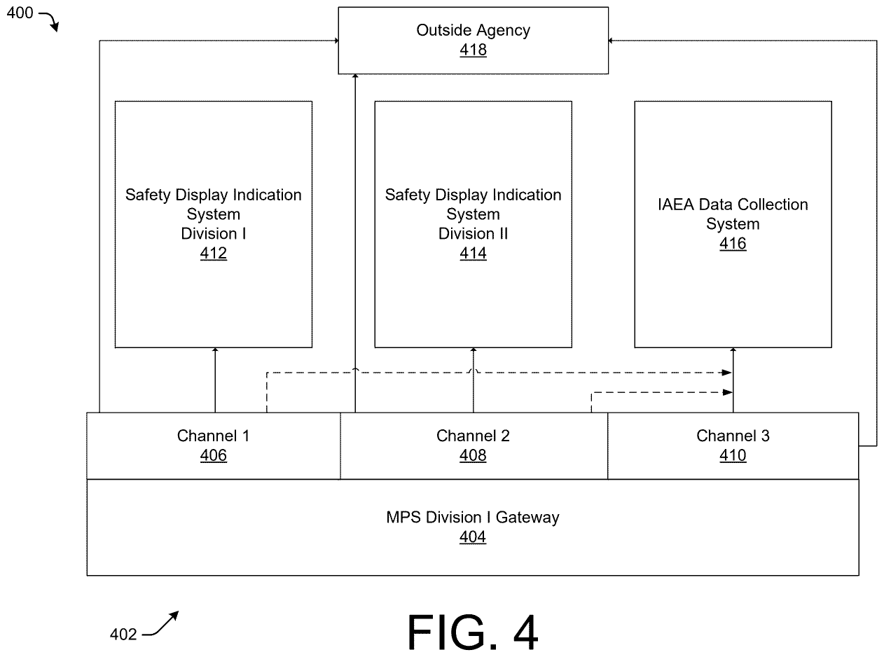

FIG. 4 schematically illustrates an NPM 400 implementing dual use for an MPS 402. In an embodiment, the MPS 402 may monitor key reactor module parameters and to shut the NPM 400 down or actuate engineered safety features (ESF) when specified limits are reached. In an embodiment, the MPS 402 may include an MPS Division I Gateway 404 (“Gateway 404”) and an MPS Division II Gateway (not shown) that is identical to the Gateway 404.

In an embodiment, the Gateway 404 may include a first channel 406 (e.g., channel 1, primary channel, etc.), a second channel 408 (e.g., channel 2, secondary channel, etc.), and a third channel 410 (e.g., channel 3, tertiary channel, etc.). In an embodiment, the first channel 406 may be configured to receive data from the Gateway 404 and transmit the data to a Safety Display Indication System Division I 412. In an embodiment, the second channel 408 may be configured to receive data from the Gateway 404 and transmit the data to a Safety Display Indication System Division II 414.

In an embodiment, the third channel 410 may be configured to receive data from the Gateway 404 and transmit the data to an IAEA Data Collection System 416. Additionally, and/or alternatively, the IAEA Data Collection System 416 may receive data from the Gateway 404, via the first channel 406. Additionally, and/or alternatively, the IAEA Data Collection System 416 may receive data from the Gateway 404, via the second channel 408.

In an embodiment, the first channel 406 may be configured to receive data from the Gateway 404 and transmit the data to an Outside Agency 418. In an embodiment, the second channel 408 may be configured to receive data from the Gateway 404 and transmit the data to an Outside Agency 418. In an embodiment, the third channel 410 may be configured to receive data from the Gateway 404 and transmit the data to an Outside Agency 418. In an embodiment, the first channel 406, the second channel 408, and the third channel 410, or combinations of two of the channels, may be configured to receive data from the Gateway 404 and transmit the data to the Outside Agency 418.

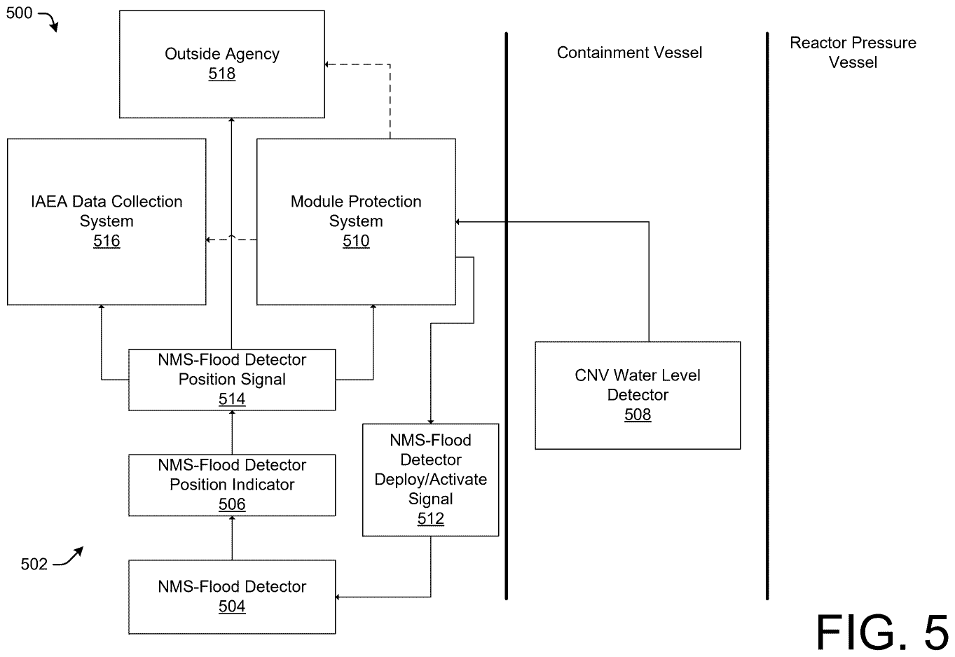

FIG. 5 schematically illustrates an NPM 500 implementing dual use for the Neutron Monitoring System (NMS)-Flood subsystem 502. In an embodiment, the NMS-Flood subsystem 502 may be located in the operating bays of a nuclear power plant and functions during flooded containment conditions (i.e., whenever water is detected within the CNV). In an embodiment, the NMS-Flood subsystem 502 may include an NMS-Flood Detector 504, an NMS-Flood Detector Position Indicator 506 (e.g., first NMS-Flood Detector Position Indicator), and a second NMS-Flood Detector Position Indicator (not shown). In an embodiment, the NMS-Flood Detector Position Indicator 506 may be identical to the second NMS-Flood Detector Position Indicator.

In an embodiment, a CNV water level detector 508 may detect water in the CNV. When the CNV water level detector 508 detects water in the CNV, the CNV water level detector 508 may send data related to CNV water level to the MPS 510. In an embodiment, the MPS 510 may send an NMS-Flood Detector Deploy/Activate Signal 512 to the NMS-Flood Detector 504 in order to activate the NMS-Flood Detector 504. The NMS-Flood Detector 504 may then cause the NMS-Flood Detector Position Indicator 506 to send an NMS-Flood Detector Position Signal 514 to the MPS 510, the IAEA Data Collection System 516, and/or an Outside Agency 518.

In an embodiment, an Outside Agency 518 and/or the IAEA Data Collection System 516, may receive data related to the NMS-Flood Detector Position Signal 514 via the NMS-Flood Detector Position Indicator 506 and/or via the MPS 510. By receiving the NMS-Flood Detector Position Signal 514 from at least two different sources (the NMS-Flood Detector Position Indicator 506 and the MPS 510), the Outside Agency 518 and/or the IAEA Data Collection System 516, may ensure redundant sources of data related to the position of the NMS-Flood Detector 504. Additionally, and/or alternatively, the Outside Agency 518 and/or the IAEA Data Collection System 516 may compare the data to ensure accuracy.

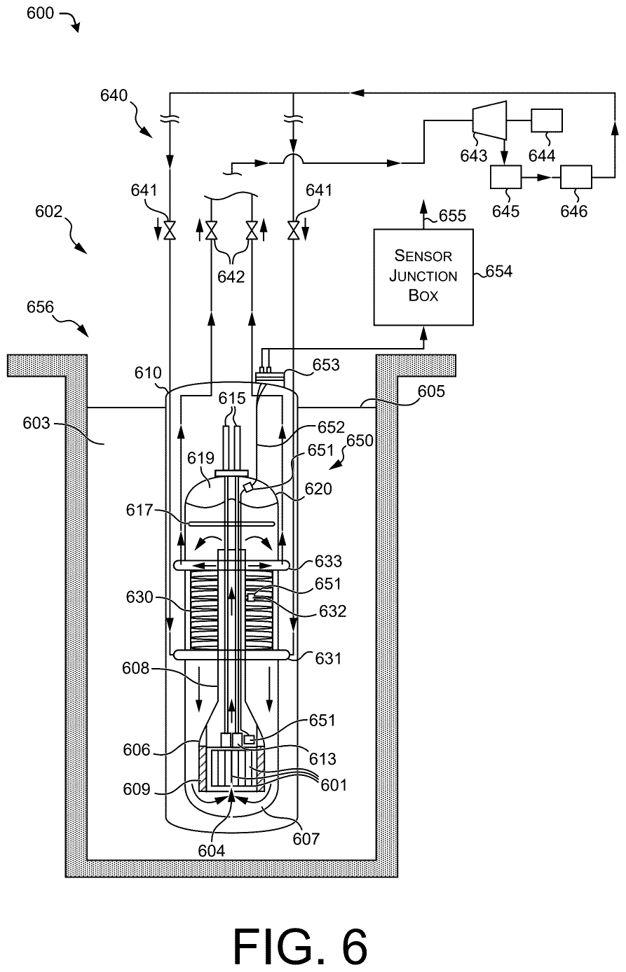

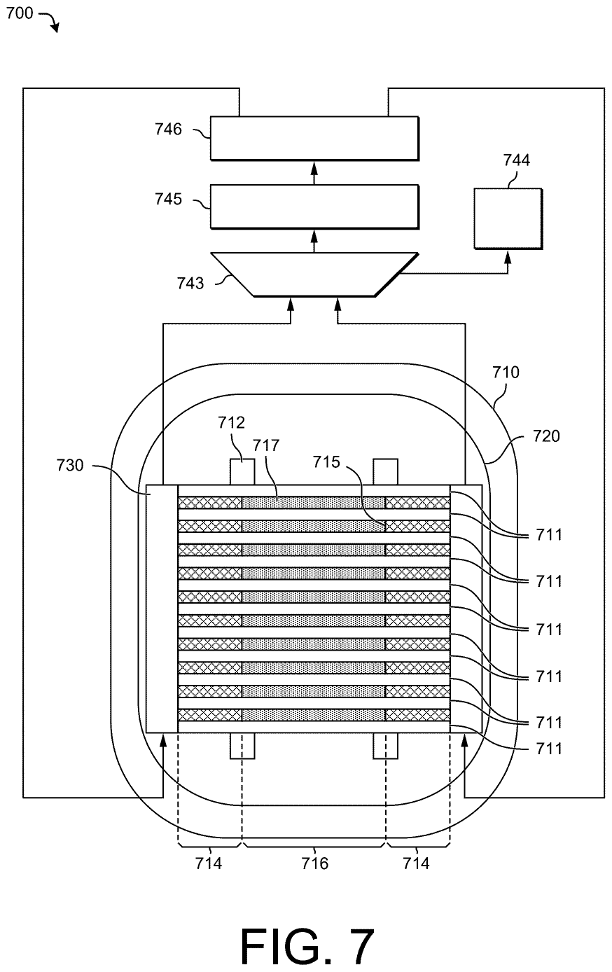

FIGS. 6 and 7 illustrate representative nuclear reactors that may be included in embodiments of the present technology. FIG. 6 is a partial schematic, partial cross-sectional view of a nuclear reactor system 600 configured in accordance with embodiments of the present technology. The system 600 can include a power module 602 having a reactor core 604 in which a controlled nuclear reaction takes place. Accordingly, the reactor core 604 can include one or more fuel assemblies 601. The fuel assemblies 601 can include fissile and/or other suitable materials. Heat from the reaction generates steam at a steam generator 630, which directs the steam to a power conversion system 640. The power conversion system 640 generates electrical power, and/or provides other useful outputs, such as super-heated steam. A sensor system 650 is used to monitor the operation of the power module 602 and/or other system components. The data obtained from the sensor system 650 can be used in real time to control the power module 602, and/or can be used to update the design of the power module 602 and/or other system components.

The power module 602 includes a containment vessel 610 (e.g., a radiation shield vessel, or a radiation shield container) that houses/encloses a reactor vessel 620 (e.g., a reactor pressure vessel, or a reactor pressure container), which in turn houses the reactor core 604. The containment vessel 610 can be housed in a power module bay 656. The power module bay 656 can contain a cooling pool 603 filled with water and/or another suitable cooling liquid. The bulk of the power module 602 can be positioned below a surface 605 of the cooling pool 603. Accordingly, the cooling pool 603 can operate as a thermal sink, for example, in the event of a system malfunction.

A volume between the reactor vessel 620 and the containment vessel 610 can be partially or completely evacuated to reduce heat transfer from the reactor vessel 620 to the surrounding environment (e.g., to the cooling pool 603). However, in other embodiments the volume between the reactor vessel 620 and the containment vessel 610 can be at least partially filled with a gas and/or a liquid that increases heat transfer between the reactor vessel 620 and the containment vessel 610. For example, the volume between the reactor vessel 620 and the containment vessel 610 can be at least partially filled (e.g., flooded with the primary coolant 607) during an emergency operation.

Within the reactor vessel 620, a primary coolant 607 conveys heat from the reactor core 604 to the steam generator 630. For example, as illustrated by arrows located within the reactor vessel 620, the primary coolant 607 is heated at the reactor core 604 toward the bottom of the reactor vessel 620. The heated primary coolant 607 (e.g., water with or without additives) rises from the reactor core 604 through a core shroud 606 and to a riser tube 608. The hot, buoyant primary coolant 607 continues to rise through the riser tube 608, then exits the riser tube 608 and passes downwardly through the steam generator 630. The steam generator 630 includes a multitude of conduits 632 that are arranged circumferentially around the riser tube 608, for example, in a helical pattern, as is shown schematically in FIG. 6. The descending primary coolant 607 transfers heat to a secondary coolant (e.g., water) within the conduits 632, and descends to the bottom of the reactor vessel 620 where the cycle begins again. The cycle can be driven by the changes in the buoyancy of the primary coolant 607, thus reducing or eliminating the need for pumps to move the primary coolant 607.

The steam generator 630 can include a feedwater header 631 at which the incoming secondary coolant enters the steam generator conduits 632. The secondary coolant rises through the conduits 632, converts to vapor (e.g., steam), and is collected at a steam header 633. The steam exits the steam header 633 and is directed to the power conversion system 640.

The power conversion system 640 can include one or more steam valves 642 that regulate the passage of high pressure, high temperature steam from the steam generator 630 to a steam turbine 643. The steam turbine 643 converts the thermal energy of the steam to electricity via a generator 644. The low-pressure steam exiting the turbine 643 is condensed at a condenser 645, and then directed (e.g., via a pump 646) to one or more feedwater valves 641. The feedwater valves 641 control the rate at which the feedwater re-enters the steam generator 630 via the feedwater header 631. In other embodiments, the steam from the steam generator 630 can be routed for direct use in an industrial process, such as a Hydrogen (H₂) and Oxygen (O₂) production plant, a chemical production plant, and/or the like, as described in detail below. Accordingly, steam exiting the steam generator 630 can bypass the power conversion system 640.

The power module 602 includes multiple control systems and associated sensors. For example, the power module 602 can include a hollow cylindrical reflector 609 that directs neutrons back into the reactor core 604 to further the nuclear reaction taking place therein. Control rods 613 are used to modulate the nuclear reaction and are driven via control rod drivers 615. The pressure within the reactor vessel 620 can be controlled via a pressurizer volume 619. The pressurizer plate 617 serves to direct the primary coolant 607 downwardly through the steam generator annulus 630 by controlling the pressure in a pressurizing volume 619 positioned above the pressurizer plate 617.

The sensor system 650 can include one or more sensors 651 positioned at a variety of locations within the power module 602 and/or elsewhere, for example, to identify operating parameter values and/or changes in parameter values. The data collected by the sensor system 650 can then be used to control the operation of the system 600, and/or to generate operational changes for the system 600. For sensors positioned within the containment vessel 610, a sensor link 652 directs data from the sensors to a flange 653 (at which the sensor link 652 exits the containment vessel 610) and directs data to a sensor junction box 654. From there, the sensor data can be routed to one or more controllers and/or other data systems via a data bus 655.

FIG. 7 is a partially schematic, partially cross-sectional view of a nuclear reactor system 700 configured in accordance with additional embodiments of the present technology. In some embodiments, the nuclear reactor system 700 (“system 700”) can include some features that are at least generally similar in structure and function, or identical in structure and function, to the corresponding features of the system 600 described in detail above with reference to FIG. 6, and can operate in a generally similar or identical manner to the system 600.

In the illustrated embodiment, the system 700 includes a reactor vessel 720 and a containment vessel 710 surrounding/enclosing the reactor vessel 720. In some embodiments, the reactor vessel 720 and the containment vessel 710 can be roughly cylinder-shaped or capsule-shaped. The system 700 further includes a plurality of heat pipe layers 711 within the reactor vessel 720. In the illustrated embodiment, the heat pipe layers 711 are spaced apart from and stacked over one another. In some embodiments, the heat pipe layers 711 can be mounted/secured to a common frame 712, a portion of the reactor vessel 720 (e.g., a wall thereof), and/or other suitable structures within the reactor vessel 720. In other embodiments, the heat pipe layers 711 can be directly stacked on top of one another such that each of the heat pipe layers 711 supports and/or is supported by one or more of the other ones of the heat pipe layers 711.

In the illustrated embodiment, the system 700 further includes a shield or reflector region 714 at least partially surrounding a core region 716. The heat pipe layers 711 can be circular, rectilinear, polygonal, and/or can have other shapes, such that the core region 716 has a corresponding three-dimensional shape (e.g., cylindrical, spherical). In some embodiments, the core region 716 is separated from the reflector region 714 by a core barrier 715, such as a metal wall. The core region 716 can include one or more fuel sources, such as fissile material, for heating the heat pipe layers 711. The reflector region 714 can include one or more materials configured to contain/reflect products generated by burning the fuel in the core region 716 during operation of the system 700. For example, the reflector region 714 can include a liquid or solid material configured to reflect neutrons and/or other fission products radially inward toward the core region 716. In some embodiments, the reflector region 714 can entirely surround the core region 716. In other embodiments, the reflector region 714 may partially surround the core region 716. In some embodiments, the core region 716 can include a control material 717, such as a moderator and/or coolant. The control material 717 can at least partially surround the heat pipe layers 711 in the core region 716 and can transfer heat therebetween.

In the illustrated embodiment, the system 700 further includes at least one heat exchanger 730 (e.g., a steam generator) positioned around the heat pipe layers 711. The heat pipe layers 711 can extend from the core region 716 and at least partially into the reflector region 714 and are thermally coupled to the heat exchanger 730. In some embodiments, the heat exchanger 730 can be positioned outside of or partially within the reflector region 714. The heat pipe layers 711 provide a heat transfer path from the core region 716 to the heat exchanger 730. For example, the heat pipe layers 711 can each include an array of heat pipes that provide a heat transfer path from the core region 716 to the heat exchanger 730. When the system 700 operates, the fuel in the core region 716 can heat and vaporize a fluid within the heat pipes in the heat pipe layers 711, and the fluid can carry the heat to the heat exchanger 730. The heat pipes in the heat pipe layers 711 can then return the fluid toward the core region 716 via wicking, gravity, and/or other means to be heated and vaporized once again.

In some embodiments, the heat exchanger 730 can be similar to the steam generator 630 of FIG. 6 and, for example, can include one or more helically-coiled tubes that wrap around the heat pipe layers 711. The tubes of the heat exchanger 730 can include or carry a working fluid (e.g., a coolant such as water or another fluid) that carries the heat from the heat pipe layers 711 out of the reactor vessel 720 and the containment vessel 710 for use in generating electricity, steam, and/or the like. For example, in the illustrated embodiment the heat exchanger 730 is operably coupled to a turbine 743, a generator 744, a condenser 745, and a pump 746. As the working fluid within the heat exchanger 730 increases in temperature, the working fluid may begin to boil and vaporize. The vaporized working fluid (e.g., steam) may be used to drive the turbine 743 to convert the thermal potential energy of the working fluid into electrical energy via the generator 744. The condenser 745 can condense the working fluid after it passes through the turbine 743, and the pump 746 can direct the working fluid back to the heat exchanger 730 where it can begin another thermal cycle. In other embodiments, steam from the heat exchanger 730 can be routed for direct use in an industrial process, such as an enhanced oil recovery operation described in detail below. Accordingly, steam exiting the heat exchanger 730 can bypass the turbine 743, the generator 744, the condenser 745, the pump 746, etc.

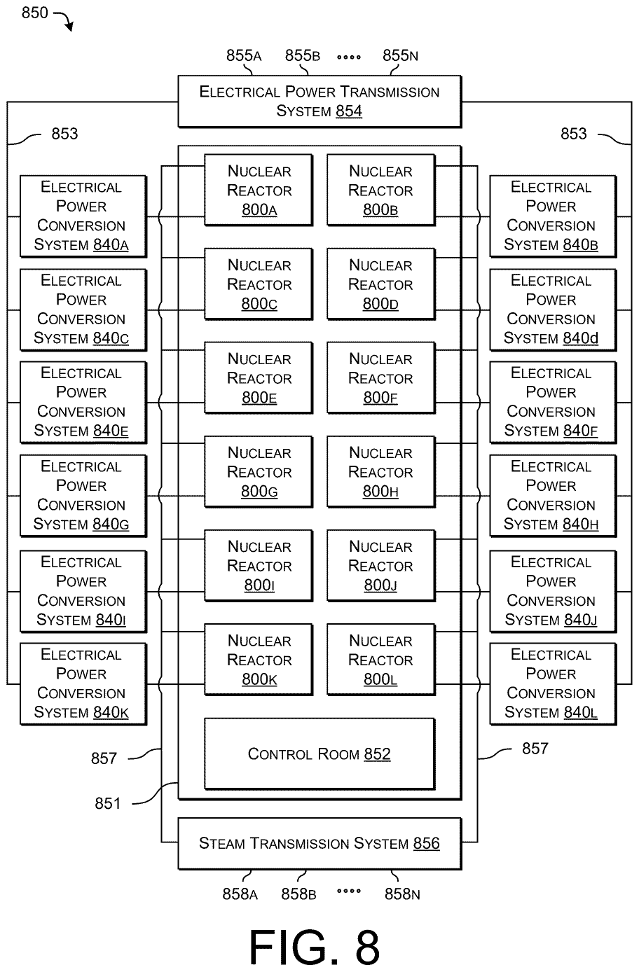

FIG. 8 is a schematic view of a nuclear power plant system 850 including multiple nuclear reactors 800 in accordance with embodiments of the present technology. Each of the nuclear reactors 800 (individually identified as first through twelfth nuclear reactors 800a-l, respectively) can be similar to or identical to the nuclear reactor 800 and/or the nuclear reactor 800 described in detail above with reference to FIGS. 6 and 7. The power plant system 850 (“power plant system 850”) can be “modular” in that each of the nuclear reactors 800 can be operated separately to provide an output, such as electricity or steam. The power plant system 850 can include fewer than twelve of the nuclear reactors 800 (e.g., two, three, four, five, six, seven, eight, nine, ten, or eleven of the nuclear reactors 800), or more than twelve of the nuclear reactors 800. The power plant system 850 can be a permanent installation or can be mobile (e.g., mounted on a truck, tractor, mobile platform, and/or the like). In the illustrated embodiment, each of the nuclear reactors 800 can be positioned within a common housing 851, such as a reactor plant building, and controlled and/or monitored via a control room 852.

Each of the nuclear reactors 800 can be coupled to a corresponding electrical power conversion system 840 (individually identified as first through twelfth electrical power conversion systems 840a-l, respectively). The electrical power conversion systems 840 can include one or more devices that generate electrical power or some other form of usable power from steam generated by the nuclear reactors 800. In some embodiments, multiple ones of the nuclear reactors 800 can be coupled to the same one of the electrical power conversion systems 840 and/or one or more of the nuclear reactors 800 can be coupled to multiple ones of the electrical power conversion systems 840 such that there is not a one-to-one correspondence between the nuclear reactors 800 and the electrical power conversion systems 840.

The electrical power conversion systems 840 can be further coupled to an electrical power transmission system 854 via, for example, an electrical power bus 853. The electrical power transmission system 854 and/or the electrical power bus 853 can include one or more transmission lines, transformers, and/or the like for regulating the current, voltage, and/or other characteristic(s) of the electricity generated by the electrical power conversion systems 840. The electrical power transmission system 854 can route electricity via a plurality of electrical output paths 855 (individually identified as electrical output paths 855a-n) to one or more end users and/or end uses, such as different electrical loads of an integrated energy system.

Each of the nuclear reactors 800 can further be coupled to a steam transmission system 856 via, for example, a steam bus 857. The steam bus 857 can route steam generated from the nuclear reactors 800 to the steam transmission system 856 which in tum can route the steam via a plurality of steam output paths 858 (individually identified as steam output paths 858a-n) to one or more end users and/or end uses, such as different steam inputs of an integrated energy system.

In some embodiments, the nuclear reactors 800 can be individually controlled (e.g., via the control room 852) to provide steam to the steam transmission system 856 and/or steam to the corresponding one of the electrical power conversion systems 840 to provide electricity to the electrical power transmission system 854. In some embodiments, the nuclear reactors 800 are configured to provide steam either to the steam bus 857 or to the corresponding one of the electrical power conversion systems 840 and can be rapidly and efficiently switched between providing steam to either. Accordingly, in some aspects of the present technology the nuclear reactors 800 can be modularly and flexibly controlled such that the power plant system 850 can provide differing levels/amounts of electricity via the electrical power transmission system 854 and/or steam via the steam transmission system 856. For example, where the power plant system 850 is used to provide electricity and steam to one or more industrial process-such as various components of the integrated energy systems, the nuclear reactors 800 can be controlled to meet the differing electricity and steam requirements of the industrial processes.

As one example, during a first operational state of an integrated energy system employing the power plant system 850, a first subset of the nuclear reactors 800 (e.g., the first through sixth nuclear reactors 800a-f) can be configured to provide steam to the steam transmission system 856 for use in the first operational state of the integrated energy system, while a second subset of the nuclear reactors 800 (e.g., the seventh through twelfth nuclear reactors 800g-l) can be configured to provide steam to the corresponding ones of the electrical power conversion systems 840 (e.g., the seventh through twelfth electrical power conversion systems 840g-l) to generate electricity for the first operational state of the integrated energy system. Then, during a second operational state of the integrated energy system when a different (e.g., greater or lesser) amount of steam and/or electricity is required, some or all the first subset of the nuclear reactors 800 can be switched to provide steam to the corresponding ones of the electrical power conversion systems 840 (e.g., the seventh through twelfth electrical power conversion systems 840g-l) and/or some or all of the second subset of the nuclear reactors 800 can be switched to provide steam to the steam transmission system 856 to vary the amount of steam and electricity produced to match the requirements/demands of the second operational state. Other variations of steam and electricity generation are possible based on the needs of the integrated energy system. That is, the nuclear reactors 800 can be dynamically/flexibly controlled during other operational states of an integrated energy system to meet the steam and electricity requirements of the operational state.

In contrast, some conventional nuclear power plant systems can typically generate either steam or electricity for output and cannot be modularly controlled to provide varying levels of steam and electricity for output. Moreover, it is typically difficult (e.g., expensive, time consuming, etc.) to switch between steam generation and electricity generation in conventional nuclear power plant systems. Specifically, for example, it is typically extremely time consuming to switch between steam generation and electricity generation in prototypical large nuclear power plant systems.

The nuclear reactors 800 can be individually controlled via one or more operators and/or via a computer system. Accordingly, many embodiments of the technology described herein may take the form of computer- or machine- or controller-executable instructions, including routines executed by a programmable computer or controller. Those skilled in the relevant art will appreciate that the technology can be practiced on computer/controller systems other than those shown and described herein. The technology can be embodied in a special-purpose computer, controller or data processor that is specifically programmed, configured, or constructed to perform one or more of the computer-executable instructions described below. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a liquid crystal display (LCD).

The technology can also be practiced in distributed environments, where tasks or modules are performed by remote processing devices that are linked through a communications network. In a distributed computing environment, program modules or subroutines may be located in local and remote memory storage devices. Aspects of the technology described herein may be stored or distributed on computer-readable media, including magnetic or optically readable or removable computer disks, as well as distributed electronically over networks. Data structures and transmissions of data particular to aspects of the technology are also encompassed within the scope of the embodiments of the technology.

### Conclusion

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

As used herein, terms such as “attached,” “fastened,” “secured,” “disposed,” “connected,” and “coupled” (including variations thereof) are intended to be used interchangeably to refer to any form of interaction between components, whether directly or indirectly, permanently or temporarily, mechanically or otherwise. It will be understood that these terms are not intended to limit the nature of the interaction to a direct or immediate connection unless specifically stated and may include indirect connections through one or more intermediary elements. Likewise, the terms “directly” and “indirectly” describe both physical contact between components and connections made through intermediate structures, mechanisms, or devices.

What is claimed is:

1. A nuclear power plant system, comprising:
a crane;
a nuclear reactor; and
a plurality of instruments, wherein:
an instrument of the plurality is configured to monitor a parameter of the nuclear power plant system,
each instrument of the plurality is configured to transmit data to a local data collection system, and
each instrument of the plurality is configured to transmit the data to an external data collection system.

2. The nuclear power plant system according to claim 1, wherein the data is transmitted to the local data collection system and not to the external data collection system.

3. The nuclear power plant system according to claim 1, wherein the data is unalterable.

4. The nuclear power plant system according to claim 1, wherein the data is encrypted prior to being transmitted to the local data collection system and the external data collection system.

5. The nuclear power plant system according to claim 1, wherein the data is formatted prior to being sent to at least one of the local data collection system and the external data collection system.

6. The nuclear power plant system according to claim 1, wherein at least one of the local data collection system and the external data collection system is associated with an International Atomic Energy Agency.

7. The nuclear power plant system according to claim 1, wherein at least one of the local data collection system and the external data collection system is associated with a Nuclear Regulatory Commission.

8. A nuclear power plant system comprising:
one or more processors; and
one or more computer-readable media storing instructions executable by the one or more processors, wherein the instructions, when executed by the one or more processors, cause the one or more processors to perform operations comprising:
receiving data from a plurality of instruments, wherein an instrument of the plurality is configured to monitor a parameter of the nuclear power plant system,
transmitting, via the plurality of instruments, the data to a first data collection system,
determining, based at least on first condition, a portion of the data, and
transmitting, via the plurality of instruments, the portion of the data to a second data collection system.

9. The nuclear power plant system according to claim 8, the operations further comprising:
determining, based at least on a second condition, a second portion of the data, and
transmitting, via the plurality of instruments, the second portion of the data to a third data collection.

10. The nuclear power plant system according to claim 8, wherein the data is unalterable.

11. The nuclear power plant system according to claim 8, wherein the data is encrypted prior to being transmitted to the first data collection system.

12. The nuclear power plant system according to claim 8, wherein the portion of the data is encrypted prior to being transmitted to the second data collection system.

13. The nuclear power plant system according to claim 8, wherein the data is formatted prior to being transmitted to the first data collection system.

14. The nuclear power plant system according to claim 8, wherein the portion of the data is formatted prior to being transmitted to the second data collection system.

15. The nuclear power plant system according to claim 8, wherein the second data collection system is associated with an International Atomic Energy Agency.

16. A method comprising:
receiving data from a plurality of instruments, wherein an instrument of the plurality is configured to monitor a parameter of a nuclear power plant system,
transmitting, via the plurality of instruments, the data to a first data collection system,
determining, based at least on a condition, a portion of the data, and
transmitting, via the plurality of instruments, the portion of the data to a second data collection system.

17. The method according to claim 16, wherein the data is unalterable.

18. The method according to claim 16, wherein the data is encrypted prior to being transmitted to the first data collection system.

19. The method according to claim 16, wherein the portion of the data is encrypted prior to being transmitted to the second data collection system.

20. The method according to claim 16, wherein the portion of the data is formatted prior to being transmitted to the second data collection system.
